(19) United States
(12) Patent Application Publication
(10) Pub. No.: US 2003/0014186 A1
(43) Pub. Date: Jan. 16, 2003

(54) Apparatus, system, and method for determining a user position and progress along a path

(75) Inventors: Hugh William Adams JR., Wappingers Falls, NY (US); Thomas Anthony Cofino, Rye, NY (US); Robert Glenn Stubbs JR., Hopewell Junction, NY (US)

Correspondence Address: Ryan, Mason & Lewis, LLP, Suite 205, 1300 Post Road, Fairfield, CT, 06430, US

(73) Assignee: International Business Machines Corporation, Armonk, NY (US)

(21) Appl. No.: 10/231,358

(22) Filed: Aug. 29, 2002

Related U.S. Application Data
(63) Continuation of application No. 09/712,989, filed on Nov. 15, 2000.

(51) Int. Cl. G01C 21/26

(52) U.S. Cl. 701/207; 701/213

(57) ABSTRACT

A device has one or more memories that store a set of position points defining respective locations within one or more physical areas. A communication interface on the device communicates with one or more signal sources located at one or more of the respective locations proximate to the position detection device. Each of the signal sources responds to the device with information about the respective location. A path process defines one or more paths connecting one or more of the position points in response to a user query. The path process accesses the information from one or more of the signal sources and determines the progress of the device user through the physical area as defined by the path. A user interface communicates the progress through the physical area to the user.

### CROSS REFERENCE TO RELATED APPLICATIONS

This application is a continuation of U.S. patent application No. 09/712,989, filed on Nov. 15, 2000.

### FIELD OF THE INVENTION

This invention relates to locating position of objects and determining paths of objects in/through a physical space. More specifically, the invention relates to assisting users to move through physical spaces and provides them with not only with geographical positioning data but also other relevant data about the physical space—for example this is a rest room or ticket counter or a directory of the occupants of a building.

### BACKGROUND OF THE INVENTION

Efforts to use technology to provide navigational aids for blind people divide themselves into two groups. The first involves the avoidance of obstacles or dangers in the immediate environment. The traditional methods using canes or guide dogs have been augmented or, for some, replaced by laser and sonic detection devices. The second type of navigational aid involves navigation to a location, providing information about the user's current position and a route or at least a direction to a destination. Some of these use Global Positioning Satellites (GPS) to provide large area navigational support independent of the user's destination. Such systems do not work inside buildings or in large cities with tall buildings. To circumvent this problem, others base their operation local, location-specific infrared transmitting signs.

The GPS system depends upon of twenty-four global positioning satellites orbiting the earth that can transmit messages to GPS receivers. Receivers determine their position by taking the difference between the time stamp in the message and the local time in the receiver. The receiver must communicate with at least three satellites to obtain a two dimensional fix and four satellites for a three dimensional fix. Cost of a GPS implementation rises with increasing accuracy. Standard GPS can resolve location within 10 meters. Differential GPS enhances accuracy to within five meters by adding a second fixed location receiver that can be used as a standard against which to correct errors. Another type of differential GPS system uses two or more communicating units sharing the same signals from one or more satellites. Such systems, most often used for high precision activities such as surveying, can resolve locations to within a few centimeters, but command prices in excess of $20,000.

GPS is successfully being used in vehicles. The vehicles are in the streets and away from the buildings and the inaccuracy is minor in comparison to the distances traveled by the vehicle. Someone walking using GPS is not nearly as successful particularly in urban settings. The majority of the time individuals walk on sidewalks next to buildings which block and bounce the satellite signals. Bouncing signals cause inaccuracies in position determinations. Moreover, GPS does not work at all inside the buildings, where people spend most of their lives.

With error as high as it is with standard GPS, it is difficult to quickly establish the direction of a user starting to walk, let alone the position. In a city where traffic patterns and buildings interrupt walking and force directional changes, this weakness renders such systems of little use for navigation for someone walking.

A number of companies are manufacturing GPS systems for both vehicles and individuals.

Some of the major manufactures are: Novatel—Calgary, Alberta, Canada; Trimble —Sunnyvale, Calif.; Magellan—Santa Clara, Calif.; and Garmin—Olathe, Kans.

The following companies either currently offer or have announced GPS systems to aid blind individuals: Arkenstone—Sunnyvale, Calif.; A-1 Electric—Rosamond, Calif.; and Sendero Group in conjunction with Xybernaut Corporation—Fairfax, Va.

So-called “talking sign” systems transmit data via infrared from a fixed position to receivers that can be tuned to receive navigation information. Since the user must aim their receiver at the sign, receipt can sometimes provide implicit information about the direction to walk to reach the sign. See Crandall W, Remote Infrared Signage Evaluation for Transit Stations and Intersections, Journal of Rehabilitation Research and Development Vol. 36, No. Oct. 4, 1999 URL (http ://www.vard.org/jour/99/36/4/crand364.htm)—hereafter “Crandall.”

Crandall has described and critiqued the use of these signs at a subway station and on some streets of San Francisco. The signs are used to identify locations such a the ticket counters, stairway or crosswalks.

According to Crandall, the San Francisco experiment is the only known infrared-based blind navigation implementation. Such as system could be extended to provide a user-carried computer with two dimensional coordinate information, allowing that user to interpret the signals in terms of a geographical database.

Problems with the Prior Art

GPS systems have several disadvantages, as follows:

1. GPS receivers cannot operate inside most buildings where potential users spend most of their hours living and working.

2. The error of the standard systems makes it difficult to establish the user's direction as well as position, vitiating their effectiveness in situations where the user frequently must stop and restart or change direction.

3. Differential GPS is bulky and requires a fixed site and a wireless connection between sites; GPS receivers do not operate in the “urban canyons” in major cities.

4. Nonstandard GPS schemes are far too costly for individuals to buy.

5. Geographic information system databases used to interpret GPS data are not updated to include changes, such as road work or construction, that, although temporary, are nevertheless often critical to the blind user depending upon them.

Infrared based systems have the following disadvantages:

1. The transmission signs must be purchased, installed, and maintained by some civil authority.

2. The signs depend on a power source that may fail.

3. The cost of the signs are significant in comparison to RFID tags.

Objects of the Invention

An object of this invention is an improved position determining and path finding apparatus and method.

### SUMMARY OF THE INVENTION

The present invention is a position detection device and method. The device has one or more memories that store a set of position points defining respective locations within one or more physical areas. A communication interface on the device communicates with one or more signal sources located at one or more of the respective locations proximate to the position detection device. Each of the signal sources responds to the device with information about the respective location. A path process defines one or more paths connecting one or more of the position points in response to a user query. The path process accesses the information from one or more of the signal sources and determines the progress of the device user through the physical area as defined by the path. A user interface communicates the progress through the physical area to the user.

### BRIEF DESCRIPTION OF THE FIGURES

The foregoing and other objects, aspects, and advantages will be better understood from the following non limiting detailed description of preferred embodiments of the invention with reference to the drawings that include the following:

FIG. 1 is a block diagram of the present system using the novel position detection device.

FIG. 2 is a block diagram of the device architecture.

FIG. 3 is a flow chart of a user input process.

FIG. 4 is a flow chart of a path monitoring process.

### DETAILED DESCRIPTION OF THE INVENTION

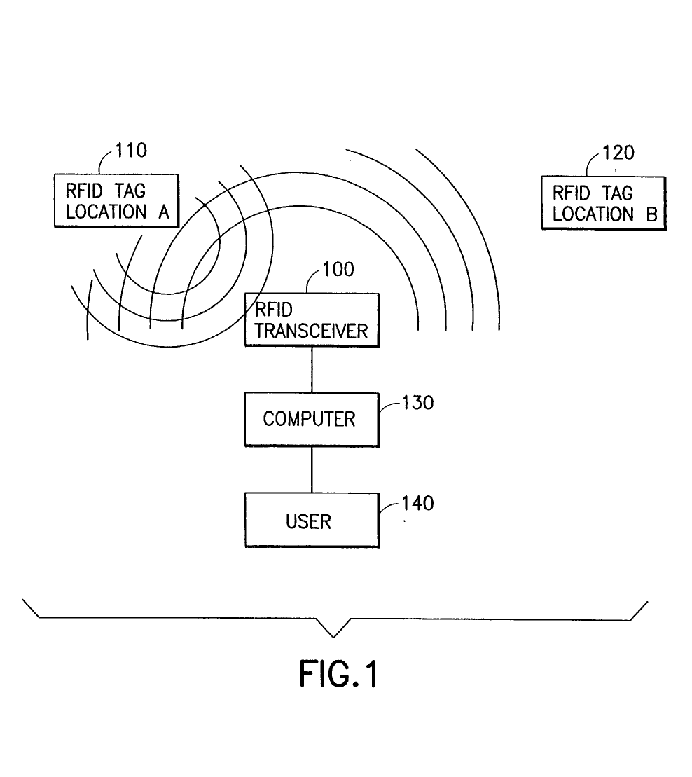

FIG. 1 is a block diagram of the present system using the novel position detection device . The radio frequency identification transceiver 100 broadcasts signals outward. Block 110 is an RFID tag for location A. The card 110 is stimulated by the signals sent from the transceiver 100 and sends return information to the transceiver 100. The computer 130 then reads the data from the transceiver 100 and uses it to interact with the user 140. RFID tag B 120, is shown as being out of range of the transceiver's 100 broadcast and does not respond to it 100. of RFID technology can be found in U.S. Pat. Nos. 5,866,044; 5,521,601; 5,528,222; 5,538,803; 5,550.547; 5,552,778; 5,554,974; 5,563,583; 5,565,847; 5,606,323; 5,635,693; 5,673,037; 5,680,106;5,682,143; 5,729,201; 5,729,697;5,736,929; 5,739,754; 5,767,789; 5,777,561; 5,786,626; 5,812,065; 5,821,859; 5,828,318; 5,831,532; 5,850,181; 5,874,902; 5,889,489; 5,909,176; and 5,912,632, which are herein incorporated by reference in their entirety.

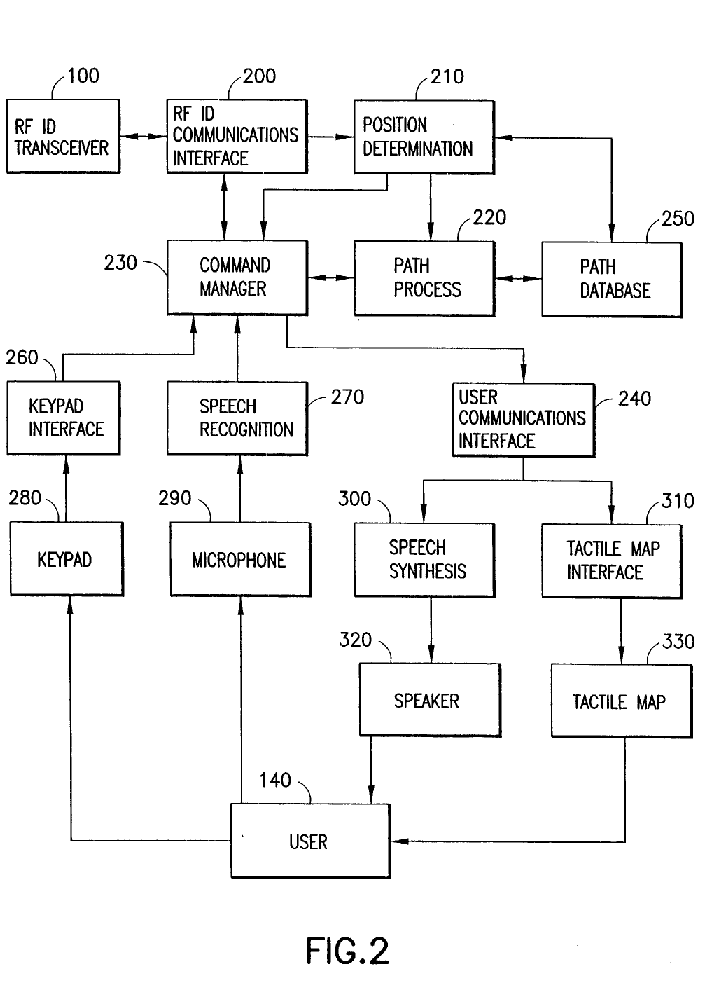

FIG. 2 is a block diagram of the device architecture. The radio frequency identification transceiver 100 stimulates RFID tags 110 and 120, reads data from the RFID tags. The transceiver 100 may also write data to the RFID tags.

RFID the communications interface 200, reads data from the RFID transceiver 100 and provides location data to position determination 210 and the command manager 230. In addition the RFID communications interface 200 may command the RFID transceiver 100 to write data to specific RFID tags.

Position Determination 210 translates the location data received from the RFID communications interface 200 into a known position and specific location data. It 210 then passes this position data to the path process 220, where the new position is used to plot the user progress along the current calculated path. The path process 220 sends data to command manager 230 to notify the user 140 of current location and issue suggestions to change direction. When the user 140 makes a request to go to a destination, the command manager 230 issues a request to the path process 220 to either plot a new path using data from the path database 250, or retrieve a stored user path from the path database 250.

The users 140 inputs requests into the system either through the keypad 280 or speech via the microphone 290. The keypad interface 260 and speech recognition 270 interpret the user input and provide it to the command manager 230. When the system has data to communicate to the user 140, the command manager 230, formats the message and the user communication interface 240 sends the message to either speech synthesis 300 or the tactile map interface 310. The speech synthesis 300 converts the output message from text to audio which is heard through the speaker 320. The tactile map interface 310 updates the tactile map 330 to indicate the current user position and directions to the destination.

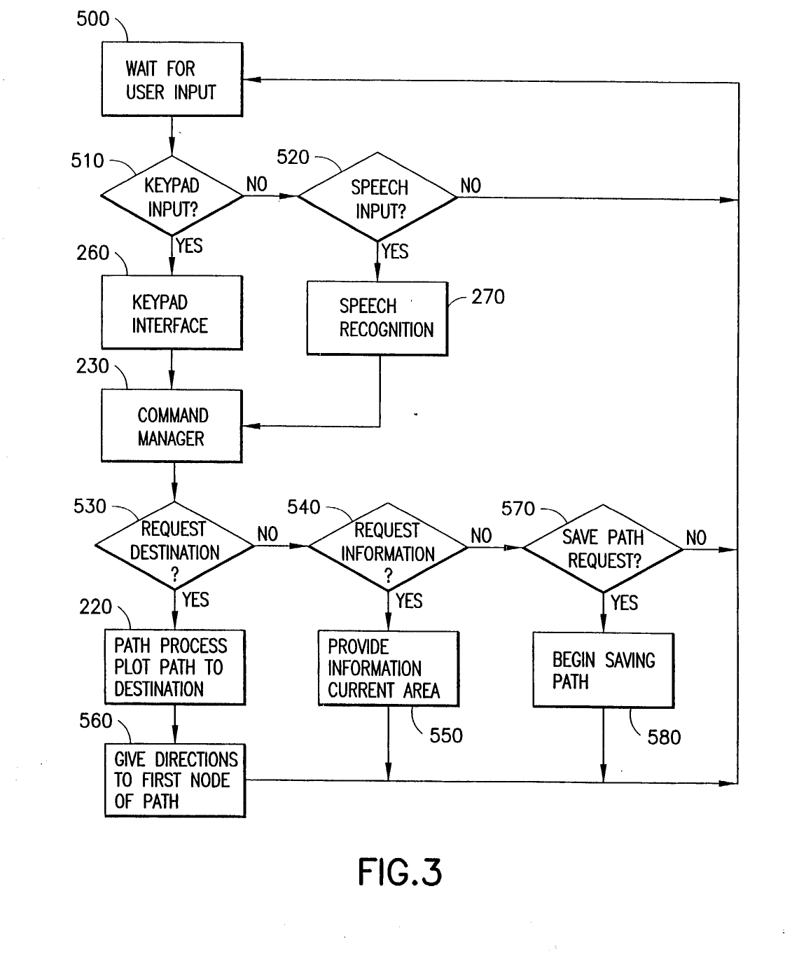

FIG. 3 is a flow chart of the processing user input. The process is input driven by either speech recognition 270 or the keypad 280. This process is normally in the idle state waiting for input 500. If the input is determined to be from the keypad 510, the keypad interface 260 translates the input to a command request and transfers the request to the command manager 230. Similarly the speech recognition 270 translates user speech into a user request and transfers the request to the command manager 230.

The command manager 230, tests if the user has requested assistance in going to a destination 530. If it is a destination request, the path process 220 plots the path to the destination and then the user is given directions 560 to the first node of the path to the destination. If the request is a status request 540, the user is given information about the current location 550. If the command is a request to save the path progress 570, the process of saving the path nodes is begun 580.

After processing the user request, the process returns to waiting for user input 500.

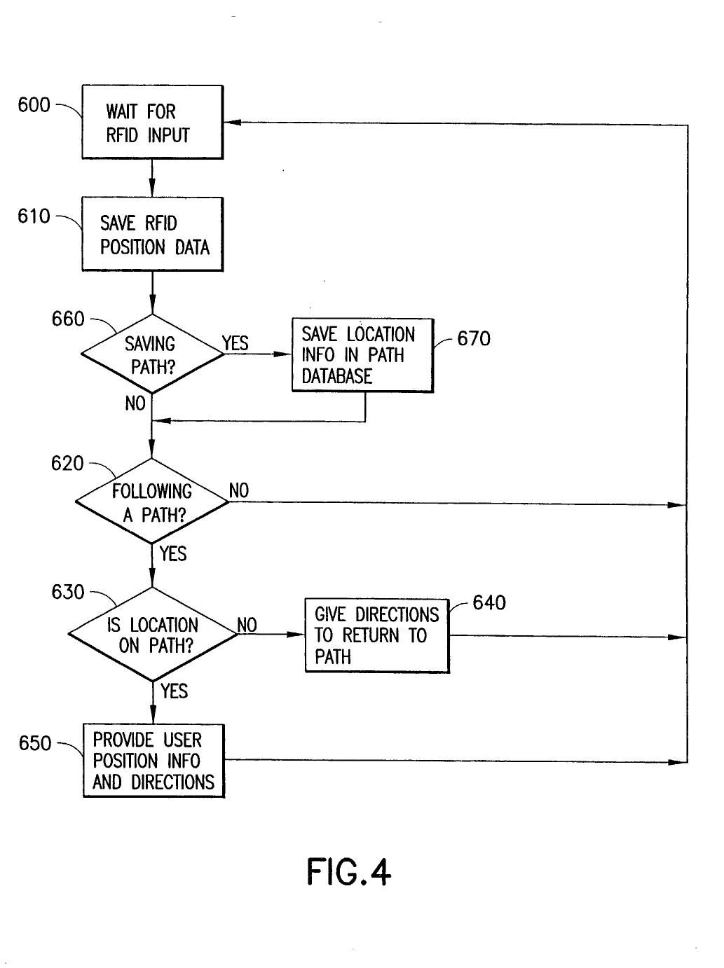

FIG. 4 is a flow chart of a path monitoring process. This process is normally waiting for RFID input 600. Whenever input is received its is saved as the current position information 610. If the progression along the path is being saved 660, the location information is saved in the path database 670. If the user is currently following a path 620, The position is tested for being along the current path 630. If the position is not on the path, directions are given on how to return to the path 640. On the other hand if this position is on the current path 630, the user is given position information and possibly directions for proceeding to the next node along the path 650.

We claim:

1. A position detection device comprising:
one or more memories that store a set of position points defining respective locations within one or more physical areas;
a communication interface for communicating with one or more signal sources located at one or more of the respective locations proximate to the position detection device, each of the signal sources having information about its respective location, each of the signal sources comprising at least one radio frequency identification tag that is stimulated by at least one signal sent from the communication interface and that returns the information to the communication interface;
a path process that defines one or more paths connecting one or more of the position points in response to a user query, the path process further accessing the information from one or more of the signal sources to determine a progress through the physical area as defined by the path; and
an interface that communicates the progress through the physical area to the user.

2. A device, as in claim 1, where the physical area includes any one or more of the following: a street, an interior of a building, a transit station, a retail store, and a town.

3. A device, as in claim 1, where the information includes non position information about the respective location.

4. A device, as in claim 3, where the non position information includes any one or more of the following information types: a building name, an address, a surname, a business name, a work place, a hotel, a restaurant, a civic directory, a performance program, a residence address, a directory of occupants, a set of directions to a next location, a warning, a designation of one or more obstacles, a route, a public announcement, a government notice, tourist information, and exhibit information.

5. A device, as in claim 1, wherein the interface further comprises a tactile map interface that updates a tactile map to indicate a current user position and at least one direction to a destination.

6. A device, as in claim 5, wherein the interface further comprises a speech synthesis module that converts the progress from text to audio.

7. A method comprising the steps of:
storing in a memory a set of position points defining respective locations within one or more physical areas;
communicating with one or more signal sources located at one or more of the respective locations proximate to a position detection device, each of the signal sources having information about the respective location, each of the signal sources comprising at least one radio frequency identification tag that is stimulated by at least one signal sent from the communication interface and that returns the information to the communication interface;
defining one or more paths connecting one or more of the position points in response to a user query;
accessing the information from one or more of the signal sources to determine a progress through the physical area as defined by the path; and
communicating the progress through the physical area to the user.

8. A method, as in claim 7, wherein the step of communicating further comprises the step of updating a tactile map to indicate a current user position and at least one direction to a destination.

9. A method, as in claim 8, wherein the step of communicating further comprises the step of converting the progress from text to audio.

10. A system for determining a position of a user comprising:
means for storing in a memory a set of position points defining respective locations within one or more physical areas;
means for communicating with one or more signal sources located at one or more of the respective locations proximate to a position detection device, each of the signal sources having information about the respective location, each of the signal sources comprising at least one radio frequency identification tag that is stimulated by at least one signal sent from the communication interface and that returns the information to the communication interface;
means for defining one or more paths connecting one or more of the position points in response to a user query;
means for accessing the information from one or more of the signal sources to determine a progress through the physical area as defined by the path; and
means for communicating the progress through the physical area to the user.

11. A system, as in claim 10, wherein the means for communicating further comprises a means for updating a tactile map to indicate a current user position and directions to a destination.

12. A system, as in claim 11, wherein the means for communicating further comprises means for converting the progress from text to audio.
